(19) United States
(12) Patent Application Publication
(10) Pub. No.: US 2018/0284805 A1
(43) Pub. Date: Oct. 4, 2018

(54) METHOD AND DEVICE FOR CONTROLLING AUTOMATIC SWEEPER

(71) Applicants: BEIJING QIHOO TECHNOLOGY COMPANY LIMITED, Beijing (CN); QIZHI SOFTWARE (BEIJING) COMPANY LIMITED, Beijing (CN)

(72) Inventor: Gaoyuan QIAO, Beijing (CN)

(73) Assignees: Beijing Qihod Technology Company Limited, Beijing (CN); Qizhi Software (Beijing) Company Limited, Beijing (CN)

(21) Appl. No.: 15/740,858

(22) PCT Filed: Oct. 26, 2016
(86) PCT No.: PCT/CN2016/103436

§ 371 Date: Dec. 29, 2017

(30) Foreign Application Priority Data
Dec. 25, 2015 (CN) 201510998382.6

(51) Int. Cl. G05D 1/02; A47L 11/40

(52) U.S. Cl. CPC G05D 1/0274; A47L 11/4011; G05D 2201/0215; A47L 2201/04; G05D 1/0223

(57) ABSTRACT

The disclosure discloses a method and device for controlling an automatic sweeper. The method comprises: recording working route information corresponding to an automatic sweeper during a moving working process of the automatic sweeper; in a case that the automatic sweeper encounters an obstacle, determining working route information within a preset period of time and respectively corresponding to moving directions adjusted according to different predetermined angles; detecting whether there exists a predetermined angle that satisfies a preset condition between the working route information and the recorded working route information; and if there exists the predetermined angle, adjusting the moving direction of the automatic sweeper in accordance with the predetermined angle.

### TECHNICAL FIELD

The disclosure relates to the technical field of sweepers, in particular to a method and a device for controlling an automatic sweeper.

### BACKGROUND

As technology advances, an automatic sweeper is used by more and more families to ease the burden of housework. The automatic sweeper is a kind of intelligent household appliances, which can complete automatically a floor sweeping task in a room by means of certain artificial intelligence. There are many automatic sweepers on the market currently, which usually can move automatically after an operating mode is turned on, thereby reducing manual operation to liberate manpower.

At present, the automatic sweeper can move automatically after an operating mode is turned on. If the automatic sweeper encounters an obstacle, it will randomly shift its moving direction and then proceeds to move in operation. However, since the moving process is often irregular, the automatic sweeper sometimes moves along repeated routes, which results in a lot of wasted machine work time and low working efficiency of the automatic sweeper.

### SUMMARY

In view of this, the disclosure provides a method and a device for controlling an automatic sweeper, and its main aim is to improve the working efficiency of an automatic sweeper.

According to one aspect of the disclosure, there is provided a method for controlling an automatic sweeper, comprising:

recording working route information corresponding to the automatic sweeper, during a moving working process of the automatic sweeper;

in a case that the automatic sweeper encounters an obstacle, determining working route information within a preset period of time and respectively corresponding to moving directions adjusted according to different predetermined angles;

detecting whether there exists a predetermined angle that satisfies a preset condition between the working route information and the recorded working route information; and

if there exists the predetermined angle, adjusting the moving direction of the automatic sweeper in accordance with the predetermined angle.

According to another aspect of the disclosure, there is provided a device for controlling an automatic sweeper, comprising:

a recording unit configured to record working route information corresponding to the automatic sweeper during a moving working process of the automatic sweeper;

a determining unit configured to, in a case that the automatic sweeper encounters an obstacle, determine working route information within a preset period of time and respectively corresponding to moving directions adjusted according to different predetermined angles;

a detecting unit configured to detect whether there exists a predetermined angle that satisfies a preset condition between the working route information determined by the determining unit and the working route information recorded by the recording unit; and

a adjusting unit configured to, if the detecting unit detects that there exists the predetermined angle that satisfies the preset condition between the working route information and the recorded working route information, adjust the moving direction of the automatic sweeper in accordance with the predetermined angle.

According to another aspect of the disclosure, there is provided a computer program comprising computer readable code which, when running on a computing apparatus, causes the computing apparatus to execute the method for controlling the automatic sweeper described above.

According to another aspect of the disclosure, there is provided a computer readable medium storing the computer program described above.

By means of the above technical solution, the technical solution according to the embodiments of the disclosure at least has the following advantages.

The method and the device for controlling the automatic sweeper are provided by the disclosure, firstly recording working route information corresponding to the automatic sweeper during a moving working process of the automatic sweeper; in a case that the automatic sweeper encounters an obstacle; then detecting whether there exists a predetermined angle that satisfies a preset condition between the working route information and the recorded working route information, determining working route information within a preset period of time and respectively corresponding to moving directions adjusted according to different predetermined angles; and if there exists the predetermined, adjusting the moving direction of the automatic sweeper in accordance with the predetermined angle. Compared with the manner of a traditional automatic sweeper randomly shifts its moving direction after it encounters an obstacle, the moving direction of the automatic sweeper may be adjusted by selecting a predetermined angle that satisfies a preset condition between the working route information and the recorded working route information, so that it can be realized that the moving direction and route of the automatic sweeper after the automatic sweeper encounters an obstacle is automatically planned, thereby avoiding excessive repeated routes, reducing the working time of the automatic sweeper, and improving the working efficiency of the automatic sweeper.

Above description is only a summary of the technical scheme of the disclosure. In order to know the technical means of the disclosure more clearly so that it can be put into effect according to the content of the description, and to make aforesaid and other purpose, features and advantages of the disclosure clearer, embodiments of the disclosure are listed below.

### BRIEF DESCRIPTION OF THE DRAWINGS

By reading the detailed description of the preferably selected embodiments below, various other advantages and benefits become clear for a person of ordinary skill in the art. The drawings are only used for showing the purpose of the preferred embodiments and are not intended to limit the disclosure. And in the whole drawings, same drawing reference signs are used for representing same components. In the drawings:

FIG. 1 illustrates a flow chart of a method for controlling an automatic sweeper in accordance with an embodiment of the disclosure;

FIG. 2 illustrates a flow chart of another method for controlling the automatic sweeper in accordance with an embodiment of the disclosure;

FIG. 3 illustrates a schematic structural diagram of the device for controlling the automatic sweeper in accordance with the embodiment of the disclosure;

FIG. 4 illustrates a schematic structural diagram of another device for controlling the automatic sweeper in accordance with the embodiment of the disclosure;

FIG. 5 illustrates a generated working route graph in accordance with an embodiment of the disclosure;

FIG. 6 schematically illustrates a block diagram of a computing apparatus for executing the method according to the disclosure; and

FIG. 7 schematically illustrates a block diagram of a storage cell for holding or carrying program codes for implementing the method for controlling the automatic sweeper according to the embodiment of the disclosure.

### DETAILED DESCRIPTION

The disclosure is further described below with reference to the accompanying drawings and exemplary embodiments, examples of which are illustrated in the accompanying drawings, wherein the same or similar reference numerals denote the same or similar elements or elements having the same or similar functions throughout the drawings. The embodiments described below with reference to the accompanying drawings are exemplary only to explain the disclosure, and should not be construed as limiting the disclosure. In addition, the detailed description of the known art will be omitted, if it is not necessary to reveal the features of the disclosure.

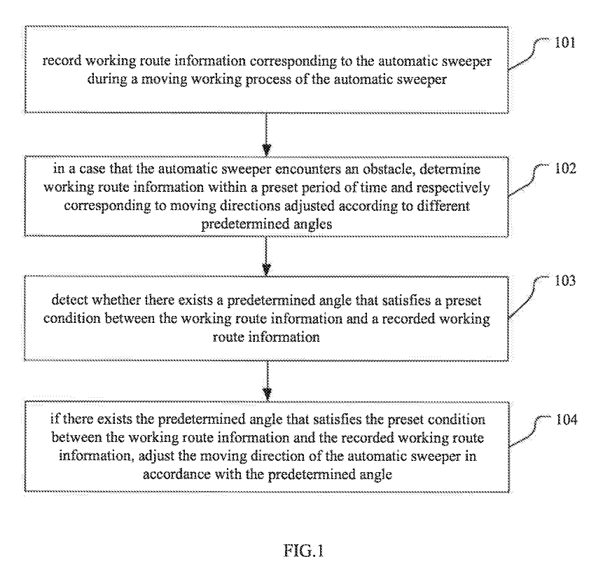

There is provided a method for controlling an automatic sweeper according to an embodiment of the disclosure, as shown in FIG. 1, which includes:

Step 101: recording working route information corresponding to the automatic sweeper during a moving working process of the automatic sweeper.

Specifically, the working route information may include a moving route of the automatic sweeper, and may also include a swept area of the automatic sweeper.

Step 102: in a case that the automatic sweeper encounters an obstacle, determining working route information within a preset period of time and respectively corresponding to moving directions adjusted according to different predetermined angles.

The preset period of time may be configured according to actual conditions. For example, the preset period of time may be configured according to the area size of a floor to be swept, and may he specifically configured to be within 10 seconds, within 15 seconds, or the like. The predetermined angle may be configured according to the user's actual requirements, and is used to adjust the moving direction of the automatic sweeper.

For example, there are 10 predetermined angles from angle 1 to angle 10. In addition, the preset period of time may be configured to be within 10 seconds according to the area size of the floor of a house. When the automatic sweeper encounters an obstacle, the working routes corresponding respectively to the moving directions adjusted according to the 10 predetermined angles within 10 seconds may be calculated in advance, that is, there are 10 working routes to choose from.

Step 103: detecting whether there exists a predetermined angle that satisfies a preset condition between the working route information and the recorded working route information.

The preset condition may be configured according to actual requirements.

For example, if the working route information includes the working route of the automatic sweeper, the preset condition may be configured that the coincidence degree between the moving route and the recorded moving route of the automatic sweeper is less than or equal to 20%. There are ten routes to choose from when the automatic sweeper encounters an obstacle, and the coincidence degree between the moving route of route 1 among the ten routes and the recorded moving route is 18%, which satisfies the preset condition. Thus, it may be determined that there is a predetermined angle between the working route information and the recorded working route information which satisfies the preset condition, i.e., the predetermined angle corresponding to the route 1.

Step 104: if there exists the predetermined angle that satisfies the preset condition between the working route information and the recorded working route information, adjusting the moving direction of the automatic sweeper in accordance with the predetermined angle.

There is provided the method for controlling the automatic sweeper according to the embodiment of the disclosure, firstly recording working route information corresponding to the automatic sweeper during a moving working process of the automatic sweeper; in a case that the automatic sweeper encounters an obstacle, determining working route information within a preset period of time and respectively corresponding to moving directions adjusted according to different predetermined angles; then detecting whether there exists a predetermined angle that satisfies a preset condition between the working route information and the recorded working route information; and if the predetermined angle exists, adjusting the moving direction of the automatic sweeper in accordance with the predetermined angle. Compared with the manner that a traditional automatic sweeper randomly shifts its moving direction after it encounters an obstacle, the moving direction of the automatic sweeper may be adjusted by selecting a predetermined angle that satisfies a preset condition between the working route information and the recorded working route information, so that it can be realized that the moving direction and route of the automatic sweeper after the automatic sweeper encounters an obstacle is automatically planned, thereby avoiding excessive repeated routes, reducing the working time of the automatic sweeper, and improving the working efficiency of the automatic sweeper.

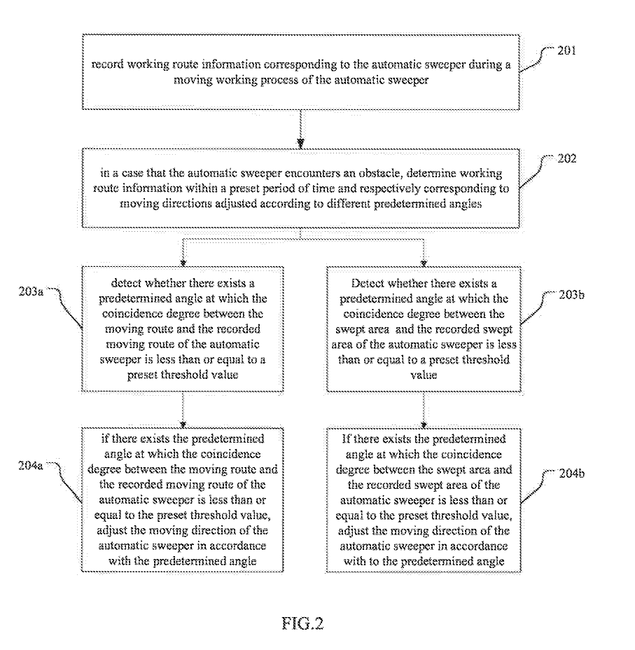

There is provided another method for controlling an automatic sweeper according to an embodiment of the disclosure, as shown in FIG. 2, which includes:

Step 201: recording working route information corresponding to the automatic sweeper during a moving working process of the automatic sweeper.

Specifically, the working route information may include a moving route of the automatic sweeper, and may also include a swept area of the automatic sweeper.

For this embodiment of the disclosure, the step of recording working route information corresponding to the automatic sweeper may further includes: acquiring a moving direction corresponding to the automatic sweeper, and acquiring a moving distance corresponding to the automatic sweeper in each moving direction; and recording working route information corresponding to the automatic sweeper according to the moving direction and the moving distance.

For this embodiment of the disclosure, the step of acquiring a moving distance corresponding to the automatic sweeper in each moving direction may further includes: acquiring a moving speed corresponding to the automatic sweeper, and a moving time in each moving direction; and calculating a product of the moving speed and the moving time as the moving distance corresponding to the automatic sweeper in each moving direction.

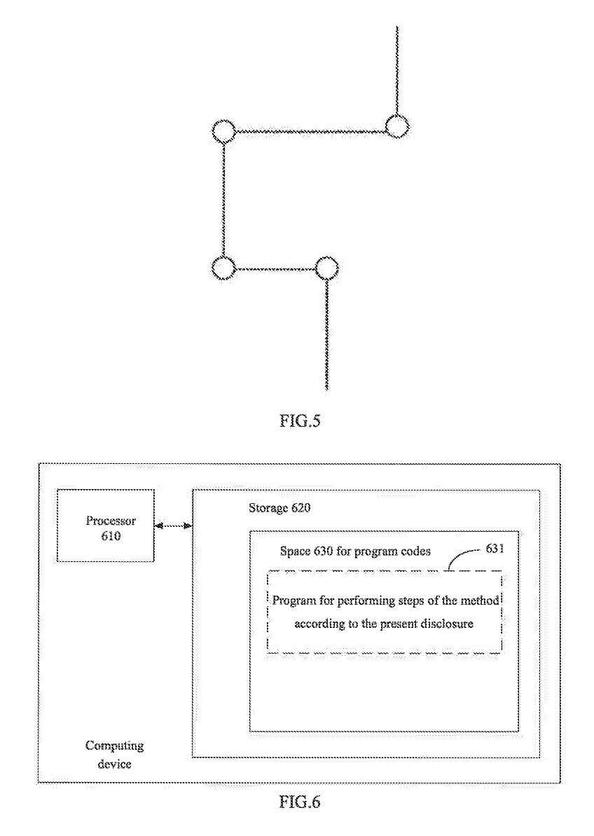

Specifically, in a case that the moving route of the automatic sweeper needs to be recorded, a working route graph may be generated according to the moving direction corresponding to the automatic sweeper and the moving distance in each moving direction, as shown in FIG. 5, wherein the straight line represents moving route of the automatic sweeper and the dot represents the encountered obstacle. In a case that the swept area of the automatic sweeper needs to be recorded, the swept width of the automatic sweeper may be acquired while acquiring the moving direction of the automatic sweeper and the moving distance in each moving direction. Further, the moving route with a width is showed in the generated working route graph, thereby calculating the swept area of the automatic sweeper.

Step 202: in a case that the automatic sweeper encounters an obstacle, determining working route information within a preset period of time and respectively corresponding to moving directions adjusted according to different predetermined angles.

Specifically, the preset period of time may be configured according to actual conditions. For example, it may be configured within 5 seconds, within 10 seconds, or the like. The predetermined angle may be configured according to the user's actual requirements, and is used to adjust the moving direction of the automatic sweeper.

For example, there are 5 predetermined angles from angle 1 to angle 5. In addition, the preset period of time may be configured to be within 10 seconds according to the area size of the floor to be swept. When the automatic sweeper encounters an obstacle, the working routes corresponding respectively to the moving directions adjusted according to the 5 predetermined angles within 10 seconds may be calculated in advance, that is, there are 5 working routes to choose from.

Step 203a: detecting whether there exists a predetermined angle at which the coincidence degree between the moving route and the recorded moving route of the automatic sweeper is less than or equal to a preset threshold value.

Specifically, the preset threshold value may be configured according to actual requirements. For example, it may be configured as 20%, 30%, or the like.

Further, after Step 203a, the method may further include: if the predetermined angle does not exist, adjusting the moving direction of the automatic sweeper by selecting a predetermined angle at which the coincidence degree between the moving route and the recorded moving route is the smallest. It should be noted that adjusting the moving direction of the automatic sweeper by selecting a predetermined angle at which the coincidence degree between the moving route and the recorded moving route is the smallest, can avoid excessive repeated routes to some extent occur and improve the working efficiency of the automatic sweeper.

Step 204a: if there exists the predetermined angle at which the coincidence degree between the moving route and the recorded moving route of the automatic sweeper is less than or equal to the preset threshold value, adjusting the moving direction of the automatic sweeper in accordance with the predetermined angle.

With the embodiment of the disclosure, by adjusting the moving direction of the automatic sweeper in accordance with the predetermined angle, it can be ensured that during moving working process of the automatic sweeper within the preset period of time after the predetermined angle is selected, the moving route would not be overlapped with too many previous routes, and thus the working efficiency of the automatic sweeping machine may be improved.

Step 203b which is juxtaposed to Step 203a: detecting whether there exists a predetermined angle at which the coincidence degree between a swept area and a recorded swept area of the automatic sweeper is less than or equal to a preset threshold value.

Further, after Step 203b, the method may further include: if the predetermined angle does not exist, adjusting the moving direction of the automatic sweeper by selecting a predetermined angle at which the coincidence degree between the swept area and the recorded swept area is the smallest. It should be noted that adjusting the moving direction of the automatic sweeper by selecting a predetermined angle at which the coincidence degree between the swept area and the recorded swept area is the smallest, can avoid excessive repeated routes to some extent occur and improve working efficiency of the automatic sweeper.

Step 204b: if there exists the predetermined angle at which the coincidence degree between the swept area and the recorded swept area of the automatic sweeper is less than or equal to the preset threshold value, adjusting the moving direction of the automatic sweeper in accordance with to the predetermined angle.

With the embodiment of the disclosure, by adjusting the moving direction of the automatic sweeper in accordance with the predetermined angle, it can be ensured that during moving working process of the automatic sweeper within the preset period of time after the predetermined angle selected, an overlapped portion of the swept area with the previous swept area would not exceed the preset threshold value, and thus the working efficiency of the automatic sweeping machine may be improved.

There is provided another method for controlling the automatic sweeper according to the embodiment of the disclosure, firstly recording working route information corresponding to the automatic sweeper during a moving working process of the automatic sweeper; if the automatic sweeper encounters an obstacle, determining working route information within a preset period of time and respectively corresponding to moving directions adjusted according to different predetermined angles; then detecting whether there exists a predetermined angle that satisfies a preset condition between the working route information and the recorded working route information; and if the predetermined angle exists, adjusting the moving direction of the automatic sweeper in accordance with the predetermined angle. Compared with the manner of a traditional automatic sweeper randomly shifts its moving direction after it encounters an obstacle, the moving direction of the automatic sweeper may be adjusted by selecting a predetermined angle that satisfies a preset condition between the working route information and the recorded working route information, so that it can be realized that the moving direction and route of the automatic sweeper after the automatic sweeper encounters an obstacle is automatically planned, thereby avoiding excessive repeated routes, reducing the working time of the automatic sweeper, and improving the working efficiency of the automatic sweeper.

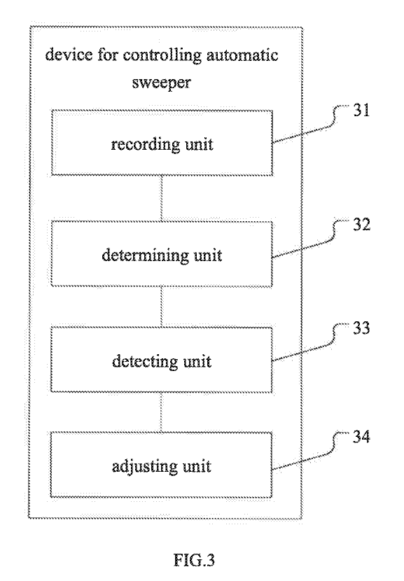

Further, there is provided a device for controlling an automatic sweeper according to an embodiment of the disclosure, as a specific implementation of the method described in FIG. 1. As shown in FIG. 3, the device includes: a recording unit 31, a determining unit 32, a detecting unit 33 and a adjusting unit 34.

The recording unit 31 may be configured to record working route information corresponding to the automatic sweeper during a moving working process of the automatic sweeper.

The determining unit 32 may be configured to, in a case that the automatic sweeper encounters an obstacle, determine working route information within a preset period of time and respectively corresponding to moving directions adjusted according to different predetermined angles.

The detecting unit 33 may be configured to detect whether there exists a predetermined angle that satisfies a preset condition between the working route information determined by the determining unit 32 and the working route information recorded by the recording unit 31.

The adjusting unit 34 may be configured to, if the detecting unit 33 detects that there exists the predetermined angle that satisfies the preset condition between the working route information and the recorded working route information, adjust the moving direction of the automatic sweeper in accordance with the predetermined angle.

It should be noted that for other corresponding descriptions of the functional units involved in the device for controlling an automatic sweeper according to an embodiment of the disclosure, reference may be made to the corresponding descriptions in FIG. 1, and details are not described herein again.

There is provided the device for controlling the automatic sweeper according to the embodiment of the disclosure, firstly recording working route information corresponding to the automatic sweeper during a moving working process of the automatic sweeper; in a case that the automatic sweeper encounters an obstacle; then detecting whether there exists a predetermined angle that satisfies a preset condition between the working route information and the recorded working route information, determining working route information within a preset period of time and respectively corresponding to moving directions adjusted according to different predetermined angles; and if the predetermined angle exists, adjusting the moving direction of the automatic sweeper in accordance with the predetermined angle. Compared with the manner of a traditional automatic sweeper randomly shifts its moving direction after it encounters an obstacle, the moving direction of the automatic sweeper may be adjusted by selecting a predetermined angle that satisfies a preset condition between the working route information and the recorded working route information, so that it can be realized that the moving direction and route of the automatic sweeper after the automatic sweeper encounters an obstacle is automatically planned, thereby avoiding excessive repeated routes, reducing the working time of the automatic sweeper, and improving the working efficiency of the automatic sweeper.

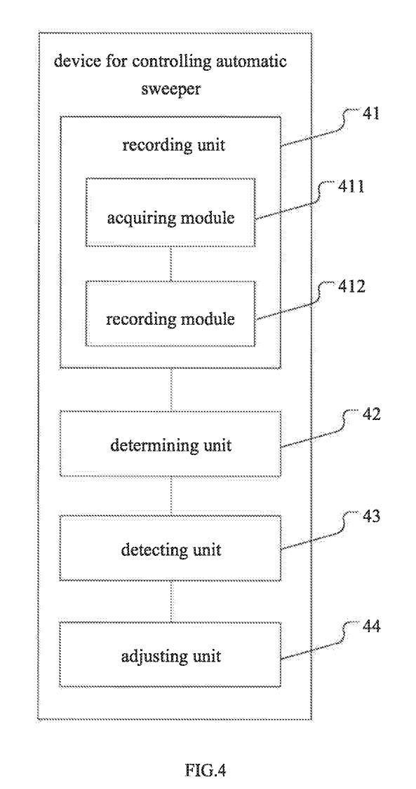

Further, there is provided another device for controlling an automatic sweeper according to an embodiment of the disclosure, as a specific implementation of the method described in FIG. 2. As shown in FIG. 4, the device includes: a recording unit 41, a determining unit 42, a detecting unit 43 and a adjusting unit 44.

The recording unit 41 may be configured to record working route information corresponding to the automatic sweeper during a moving working process of the automatic sweeper.

The determining unit 42 may be configured to, in a case that the automatic sweeper encounters an obstacle, determine working route information within a preset period of time and respectively corresponding to moving directions adjusted according to different predetermined angles.

The detecting unit 43 may be configured to detect whether there exists a predetermined angle that satisfies a preset condition between the working route information determined by the determining unit 42 and the working route information recorded by the recording unit 41.

The adjusting unit 44 may be configured to, if the detecting unit 43 detects that there exists the predetermined angle that satisfies the preset condition between the working route information and the recorded working route information, adjust the moving direction of the automatic sweeper in accordance with the predetermined angle.

Optionally, the working route information comprises a moving route of the automatic sweeper.

The detecting unit 43 may be specifically configured to detect whether there exists a predetermined angle at which the coincidence degree between the moving route and the recorded moving route is less than or equal to a preset threshold value.

The adjusting unit 44 may be further configured to, if the detecting unit 43 detects that there does not exist the predetermined angle at which the coincidence degree between the moving route and the recorded moving route is less than or equal to the preset threshold value, adjust the moving direction of the automatic sweeper by selecting a predetermined angle at which the coincidence degree between the moving route and the recorded moving route is the smallest.

Optionally, the working route information comprises a swept area of the automatic sweeper.

The detecting unit 43 may be specifically configured to detect whether there exists a predetermined angle at which the coincidence degree between the swept area and the recorded swept area is less than or equal to a preset threshold value.

The adjusting unit 44 may be further configured to, if the detecting unit 43 detects that there does not exist the predetermined angle at which the coincidence degree between the swept area and the recorded swept area is less than or equal to the preset threshold value, adjust the moving direction of the automatic sweeper by selecting a predetermined angle at which the coincidence degree between the swept area and the recorded swept area is the smallest.

Further, the recording unit 41 includes: an acquiring module 411 and a recording module 412.

The acquiring module 411 may be configured to acquire a moving direction corresponding to the automatic sweeper.

The acquiring module 411 may be further configured to acquire a moving distance corresponding to the automatic sweeper in each moving direction.

The recording module 412 may be configured to record the recording working route information corresponding to the automatic sweeper according to the moving direction and the moving distance acquired by the acquiring module 411.

The acquiring module 411 may be specifically configured to acquire a moving speed corresponding to the automatic sweeper, and a moving time in each moving direction.

The acquiring module 411 may be further specifically configured to calculate a product of the moving speed and the moving time as the moving distance corresponding to the automatic sweeper in each moving direction.

It should be noted that for other corresponding descriptions of the functional units involved in another device for controlling an automatic sweeper according to an embodiment of the disclosure, reference may be made to the corresponding descriptions in FIG. 2, and details are not described herein again.

There is provided another device for controlling the automatic sweeper according to the embodiment of the disclosure, firstly recording working route information corresponding to the automatic sweeper in a moving working process of the automatic sweeper; in a case that the automatic sweeper encounters an obstacle, determining working route information within a preset period of time and respectively corresponding to moving directions adjusted according to different predetermined angles; then detecting whether there exists a predetermined angle that satisfies a preset condition between the working route information and the recorded working route information; and if the predetermined angle exists, adjusting the moving direction of the automatic sweeper in accordance with the predetermined angle. Compared with the way of a traditional automatic sweeper randomly shifts its moving direction after it encounters an obstacle, the moving direction of the automatic sweeper may be adjusted by selecting a predetermined angle that satisfies a preset condition between the working route information and the recorded working route information, so that it can be realized that the moving direction and route of the automatic sweeper after the automatic sweeper encounters an obstacle is automatically planned, thereby avoiding excessive repeated routes, reducing the working time of the automatic sweeper, and improving the working efficiency of the automatic sweeper.

In the foregoing embodiments, the description of each embodiment has its own emphasis. For the parts that are not described in detail in one embodiment, reference may be made to related descriptions in other embodiments.

It may be understood that related features described in the above method and device may be referred to each other. In addition, “first”, “second” and the like described in the above embodiments are used to distinguish the embodiments, and do not represent the advantages and disadvantages of the embodiments.

Those skilled in the art may clearly understand that, for convenience and simplicity of description, reference may be made to corresponding processes in the foregoing method embodiment, for specific working processes of the foregoing system, device, and unit, and details are not described herein again.

The algorithm and display provided here have no inherent relation with any specific computer, virtual system or other apparatus. Various general-purpose systems can be used together with the teaching based on this. According to the above description, the structure required to construct this kind of system is obvious. Besides, the disclosure is not directed at any specific programming language. It should be understood that various programming language can be used for achieving the content of the disclosure described here, and above description of specific language is for disclosing the optimum embodiment of the disclosure.

The description provided here explains plenty of details. However, it can be understood that the embodiments of the disclosure can be implemented without these specific details. The known methods, structure and technology are not sown in detail in some embodiments, so as not to obscure the understanding of the description.

Similarly, it should be understood that in order to simplify the disclosure and help to understand one or more of the various aspects of the disclosure, the various features of the disclosure are sometimes grouped into a single embodiment, drawings, or description thereof in the above description of the exemplary embodiments of the disclosure. However, the method disclosed should not be explained as reflecting the following intention: that is, the disclosure sought for protection claims more features than the features clearly recorded in every claim. To be more precise, as is reflected in the following claims, the aspects of the disclosure are less than all the features of a single embodiment disclosed before. Therefore, the claims complying with a specific embodiment are explicitly incorporated into the specific embodiment thereby, wherein every claim itself as an independent embodiment of the disclosure.

Those skilled in the art can understand that adaptive changes can be made to the modules of the apparatus in the embodiment and the modules can be installed in one or more apparatus different from the embodiment. The modules or units or elements in the embodiment can be combined into one module or unit or element, and furthermore, they can be separated into more sub-modules or sub-units or sub-elements. Except such features and/or processes or that at least some in the unit are mutually exclusive, any combinations can be adopted to combine all the features disclosed by the description (including the attached claims, abstract and figures) and any method or all process of the apparatus or unit disclosed as such. Unless there is otherwise explicit statement, every feature disclosed by the description (including the attached claims, abstract and figures) can be replaced by substitute feature providing the same, equivalent or similar purpose.

In addition, those skilled in the art can understand that although some embodiments described here comprise some features instead of other features included in other embodiments, the combination of features of different embodiments means falling into the scope of the disclosure and forming different embodiments. For example, in the following claims, any one of the embodiments sought for protection can be used in various combination modes.

The various components embodiments of the disclosure can be realized by hardware, or realized by software modules running on one or more processors, or realized by combination thereof A person skilled in the art should understand that microprocessor or digital signal processor (DSP) can be used for realizing some or all functions of some or all components in the method and device for controlling an automatic sweeper according to the embodiments in the disclosure in practice. The disclosure can also realize one part of or all apparatus or programs (for example, computer programs and computer program products) used for carrying out the method described here. Such programs for realizing the disclosure can be stored in computer readable medium, or can possess one or more forms of signal. Such signals can be downloaded from the Internet website or be provided at signal carriers, or be provided in any other forms.

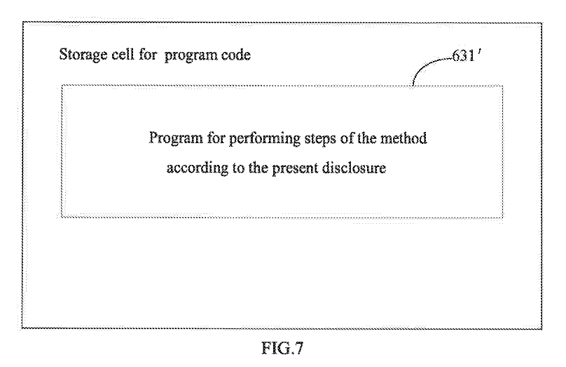

For example, FIG. 6 illustrates a block diagram of a computing apparatus for executing the method according to the disclosure. The computing apparatus traditionally includes a processor 610 and a computer program product or a computer readable medium embodying as a storage 620. The storage 620 can be electronic storage such as flash memory, EEPROM (Electrically Erasable Programmable Read-Only Memory), EPROM, hard disk or ROM, and the like. The storage 620 possesses storage space 630 which stores program code 631 for carrying out any steps of aforesaid method. For example, storage space 630 for program code can store various program codes 631 used for realizing any steps of aforesaid method. These program codes can be read out from one or more computer program products or write in one or more computer program products. The computer program products comprise program code carriers such as hard disk, Compact Disc (CD), memory card or floppy disk and the like. These computer program products usually are portable or fixed storage cell as said in FIG. 7. The storage cell can possess memory paragraph, storage space like the storage 620 in the computing apparatus in FIG. 6. The program code can be compressed in, for example, a proper form. Generally, the storage cell comprises computer readable program code 631′, i.e. the code can be read by processors such as 610 and the like. When the program codes run on a computing apparatus, the computing apparatus will carry out various steps of the method described above.

The “an embodiment”, “embodiments” or “one or more embodiments” referred here mean being included in at least one embodiment in the disclosure combining specific features, structures or characteristics described in the embodiments. In addition, please note that the phrase “in an embodiment” not necessarily mean a same embodiment.

It should be noticed that the embodiments are intended to illustrate the disclosure and not limit this disclosure, and a person skilled in the art can design substitute embodiments without departing from the scope of the appended claims. In the claims, any reference marks between brackets should not be constructed as limit for the claims. The word “comprise” does not exclude elements or steps that are not listed in the claims. The word “a” or “one” before the elements does not exclude that more such elements exist. The disclosure can be realized by means of hardware comprising several different elements and by means of properly programmed computer. In the unit claims several device are listed, several of the device can be embodied by a same hardware item. The use of words first, second and third does not mean any sequence. These words can be explained as name.

In addition, it should be noticed that the language used in the disclosure is chosen for the purpose of readability and teaching, instead of for explaining or limiting the topic of the disclosure. Therefore, it is obvious for a person skilled in the art to make a lot of modification and alteration without departing from the scope and spirit of the appended claims. For the scope of the disclosure, the disclosure is illustrative instead of restrictive. The scope of the disclosure is defined by the appended claims.

What is claimed is:

1. A method for controlling an automatic sweeper, comprising:
recording working route information corresponding to the automatic sweeper, during a owing working process of the automatic sweeper;
in a case that the automatic sweeper encounters an obstacle, determining working route information within a preset period of time and respectively corresponding to moving directions adjusted according to different predetermined angles;
detecting whether there exists a predetermined angle that satisfies a preset condition between the working route information and a recorded working route information; and
if there exists the predetermined angle, adjusting the moving direction of the automatic sweeper in accordance with the predetermined angle.

2. The method for controlling an automatic sweeper according to claim 1, wherein the working route information comprises a moving route of the automatic sweeper, and the detecting whether there exists a predetermined angle that satisfies a preset condition between the working route information and the recorded working route information further comprises:
detecting whether there exists a predetermined angle at which the coincidence degree between the moving route and a recorded moving route is less than or equal to a preset threshold value.

3. The method for controlling an automatic sweeper according to claim 2, wherein after the detecting whether there exists a predetermined angle at which the coincidence degree between the moving route and the recorded moving route is less than or equal to a preset threshold value, the method further comprises:
If there does not exist the predetermined angle, adjusting the moving direction of the automatic sweeper by selecting a predetermined angle at which the coincidence degree between the moving route and the recorded moving route is the smallest.

4. The method for controlling an automatic sweeper according to claim 1, wherein the working route information comprises a swept area of the automatic sweeper, and the detecting whether there exists a predetermined angle that satisfies a preset condition between the working route information and the recorded working route information, further comprises:
detecting whether there exists a predetermined angle at which the coincidence degree between the swept area and a recorded swept area is less than or equal to a preset threshold value.

5. The method for controlling an automatic sweeper according to claim 4, wherein after the detecting whether there exists a predetermined angle at which the coincidence degree between the swept area and the recorded swept area is less than or equal to a preset threshold value, the method further comprises:
if there does not exist the predetermined angle, adjusting the moving direction of the automatic sweeper by selecting a predetermined angle at which the coincidence degree between the swept area and a recorded swept area is the smallest.

6. The method for controlling an automatic sweeper according to claim 1, wherein the recording working route information corresponding to the automatic sweeper further comprises;
acquiring a moving direction corresponding to the automatic sweeper, and acquiring a moving distance corresponding to the automatic sweeper in each moving direction; and
recording the working route information corresponding to the automatic sweeper according to the moving direction and the moving distance.

7. The method for controlling an automatic sweeper according to claim 6, wherein the acquiring a moving distance corresponding to the automatic sweeper in each moving direction further comprises:
acquiring a moving speed corresponding to the automatic sweeper, and a moving time in each moving direction; and
calculating a product of the moving speed and the moving time as the moving distance corresponding to the automatic sweeper in each moving direction.

8. A device for controlling an automatic sweeper, comprising:
a recording unit configured to record working route information corresponding to the automatic sweeper during a moving working process of the automatic sweeper;
a determining unit configured to, in a case that the automatic sweeper encounters an obstacle, determine working route information within a preset period of time and respectively corresponding to moving directions adjusted according to different predetermined angles;
a detecting unit configured to detect whether there exists a predetermined angle that satisfies a preset condition between the working route information determined by the determining unit and the working route information recorded by the recording unit; and
a adjusting unit configured to, if the detecting unit detects that there exists the predetermined angle that satisfies the preset condition between the working route information and the recorded working route information, adjust the moving direction of the automatic sweeper in accordance with the predetermined angle.

9. The device for controlling an automatic sweeper according to claim 8, wherein the working route information comprises a moving route of the automatic sweeper, and
the detecting unit is further configured to detect whether there exists a predetermined angle at which the coincidence degree between the moving route and a recorded moving route is less than or equal to a preset threshold value.

10. The device for controlling an automatic sweeper according to claim 9, wherein
the adjusting unit is further configured to, if the detecting unit detects that there does not exist the predetermined angle at which the coincidence degree between the moving route and the recorded moving route is less than or equal to the preset threshold value, adjust the moving direction of the automatic sweeper by selecting a predetermined angle at which the coincidence degree between the moving route and the recorded moving route is the smallest.

11. The device for controlling an automatic sweeper according to claim 8, wherein
the working route information comprises a swept area of the automatic sweeper, and the detecting unit is further configured to detect whether there exists a predetermined angle at which the coincidence degree between the swept area and a recorded swept area is less than or equal to a preset threshold value.

12. The device for controlling an automatic sweeper according to claim 11, wherein
the adjusting unit is further configured to, if the detecting unit detects that there does not exist the predetermined angle at which the coincidence degree between the swept area and the recorded swept area is less than or equal to the preset threshold value, adjust the moving direction of the automatic sweeper by selecting a predetermined angle at which the coincidence degree between the swept area and the recorded swept area is the smallest.

13. The device for controlling an automatic sweeper according to claim 8, wherein the recording unit comprises:
an acquiring module, configured to acquire a moving direction corresponding to the automatic sweeper and acquire a moving distance corresponding to the automatic sweeper in each moving direction; and
a recording module, configured to record the working route information corresponding to the automatic sweeper according to the moving direction and the moving distance acquired by the acquiring module.

14. The device for controlling an automatic sweeper according to claim 13, wherein
the acquiring module is further configured to:
acquire a moving speed corresponding to the automatic sweeper, and a moving time in each moving direction; and
calculate a product of the moving speed and the moving time as the moving distance corresponding to the automatic sweeper in each moving direction.

15. A computer program comprising computer readable code which, when running on a computing apparatus, causes the computing apparatus to execute the method for controlling the automatic sweeper according to any of claims 1 to 7.

16. A computer readable medium storing the computer program according to claim 15.
